(19) United States
(12) Patent Application Publication
(10) Pub. No.: US 2010/0228380 A1
(43) Pub. Date: Sep. 9, 2010

(54) METHOD FOR IDENTIFYING THE CUTTING PATTERN FOR PIECES OF WOOD SUCH AS LOGS

(75) Inventor: Federico GIUDICEANDREA, Bressanone (IT)

Correspondence Address: Pearne & Gordon LLP, 1801 East 9th Street, Suite 1200, Cleveland, OH, 44114-3108, US

(73) Assignee: MICROTEC S.R.L., Bressanone (Bolzano) (IT)

(21) Appl. No.: 12/719,663

(22) Filed: Mar. 8, 2010

(30) Foreign Application Priority Data
Mar. 9, 2009 (IT) VR2009A000025

(51) Int. Cl. G06F 19/00

(52) U.S. Cl. 700/118

(57) ABSTRACT

A method for identifying the cutting pattern for pieces of wood such as logs comprises the following operating steps:
obtaining a virtual three-dimensional model (1) of the density of the piece of wood;
selecting a possible first virtual cutting pattern (4) for the piece of wood which may allow one or more semi-finished products (3) to be obtained from the piece of wood;
applying virtually the first virtual cutting pattern (4) to the three-dimensional model (1) of the piece of wood, to obtain one or more virtual semi-finished products (3);
virtually associating with the virtual semi-finished products (3), the corresponding density identified on the basis of the three-dimensional model (1);
processing, for each virtual semi-finished product (3), an estimate of its mechanical properties based on its density;
repeating the selection, application, association and processing steps for a plurality of different possible cutting patterns (4);
comparing the estimates regarding the mechanical properties of the virtual semi-finished products (3) which can be obtained with the different cutting patterns (4) and, based on this comparison, choosing the actual cutting pattern (4).

This invention relates to a method for identifying the cutting pattern for pieces of wood such as logs.

One of the needs most felt in the wood manufacturing sector, is to exploit the wood in the best way possible, minimizing waste and maximizing profits. In particular, for many applications, the need is to maximize profits, from the cut of semi-finished products with high mechanical characteristics (such as static resistance and modulus of elasticity).

As a consequence, the way in which each piece of wood is cut (in particular each log) is of essential importance.

To decide the cutting method for each piece of wood, this must be previously subject to a series of exams to determine the position of possible defects as cracks, knots, etc, and its structural properties. An example of this known type of solution, is described in U.S. Pat. No. 6,026,689.

In that patent, in particular, the wave propagation speed (resonance frequency) inside a log must be determined for each log, and based on this, the value of the overall modulus of elasticity of the log must be established. Once the modulus of elasticity has been determined, the economic value of the log is obtained from a table, in which the economic values are related to the sizes of the log and its modulus of elasticity.

Therefore, this method, in approximate terms, considers the mechanical properties of the log to be uniform along the entire log.

Currently, once the overall properties have been obtained for each piece of wood, the cutting patterns which are in general able to reduce waste to the minimum, guaranteeing on average, at the same time, semi-finished products of good quality, are selected assuming that the properties of the overall log are also reflected in the planks.

Nonetheless, since the log is inhomogeneous due to its nature, once the cut has been performed, it must be verified whether or not the planks meet the requirements.

To do this, there are many known methods. Among others, there are those that use radiographic exams of the planks in order to determine the internal distribution of possible knots and actual density and as a consequence, the modulus of elasticity (an example of this type of equipment is described in patent DE 44 35 975).

In general, after these checks, it is possible to verify that the mechanical properties change from plank to plank due to the presence of knots or other defects, and especially due to the density variations between the various planks, that determine significant differences with regards to the modulus of elasticity.

The known methods to choose the cutting pattern of logs for structural purposes, therefore present numerous disadvantages which are mainly linked to their limited reliability that prevents optimization of the cut.

In this situation, the technical purpose of this invention is to provide a method for identifying the cutting pattern for pieces of wood such as logs which overcomes the above-mentioned disadvantages.

In particular, the technical purpose of this invention is to provide a method for identifying the cutting pattern for pieces of wood such as logs, that allows optimization of the cutting pattern, compared to prior art methods.

It is also the technical purpose of this innovation to provide a method for identifying the cutting pattern for pieces of wood such as logs that allows estimation with a good degree of reliability of the mechanical properties of the cut products, and as a consequence, maximizes the economic value of the semi-finished products obtained from each piece of wood.

The technical purpose specified and the aims indicated are mainly achieved with a method for identifying the cutting pattern for pieces of wood such as logs as described in the appended claims.

Further characteristics and advantages of this innovation will be found in the detailed description of several preferred, but not exclusive, embodiments of a method for identifying the cutting pattern for pieces of wood such as logs, shown in the accompanying drawings, in which:

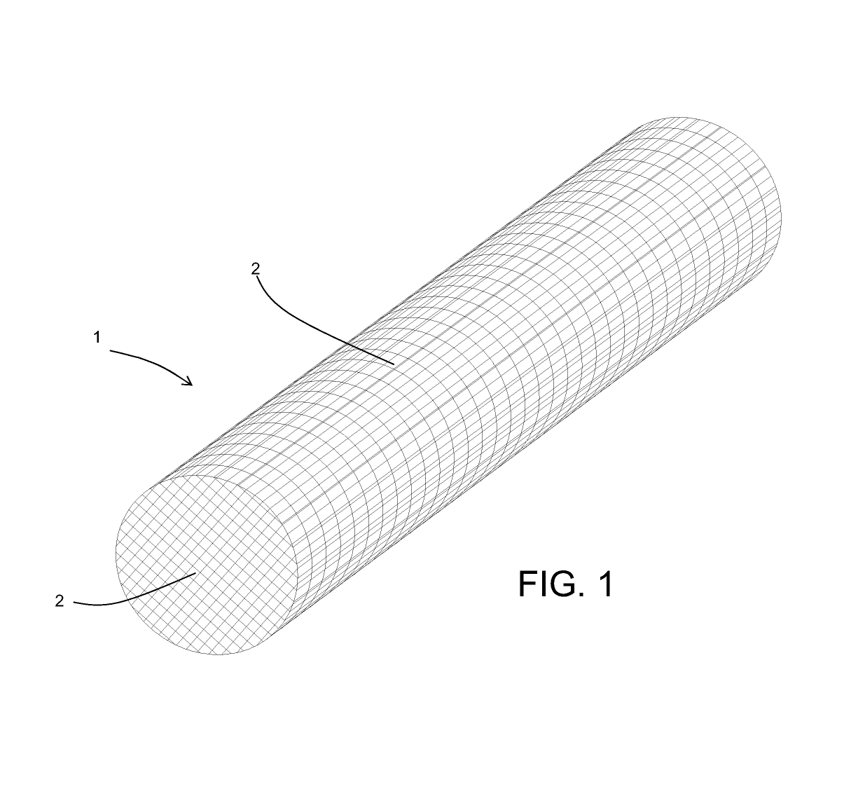

FIG. 1 shows a schematic axonometric view of a three-dimensional model of a piece of wood to cut;

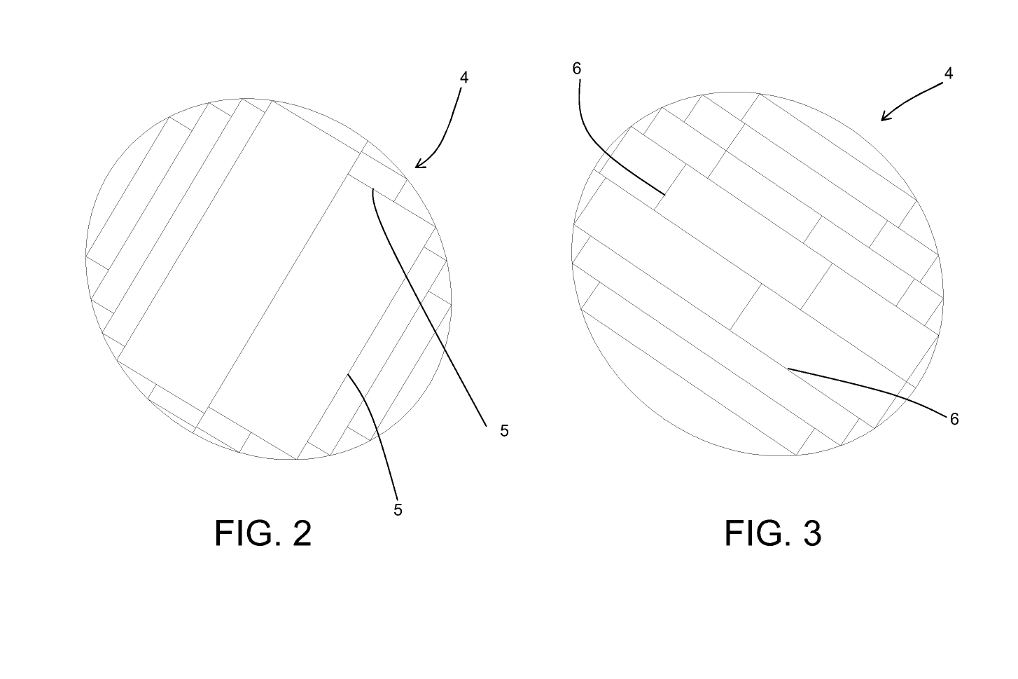

FIG. 2 shows schematically, the front view of model in FIG. 1, of a first possible cutting pattern to obtain planks;

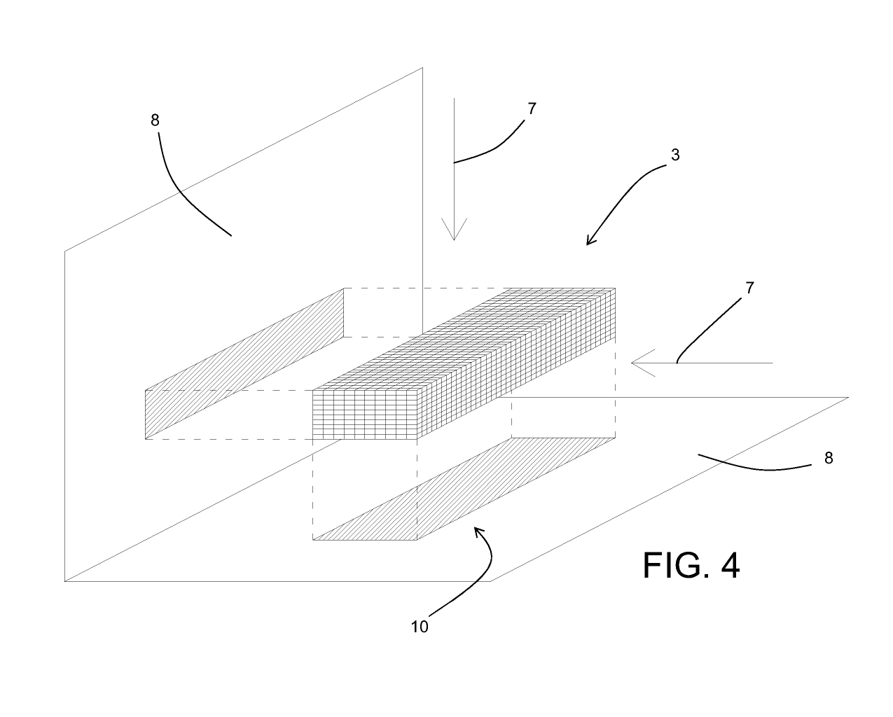

FIG. 3 shows schematically, the front view of model in FIG. 1, of a second possible cutting pattern to obtain planks;

FIG. 4 shows schematically the graphic representation of an operating step of a preferred form of the method according to this invention; and

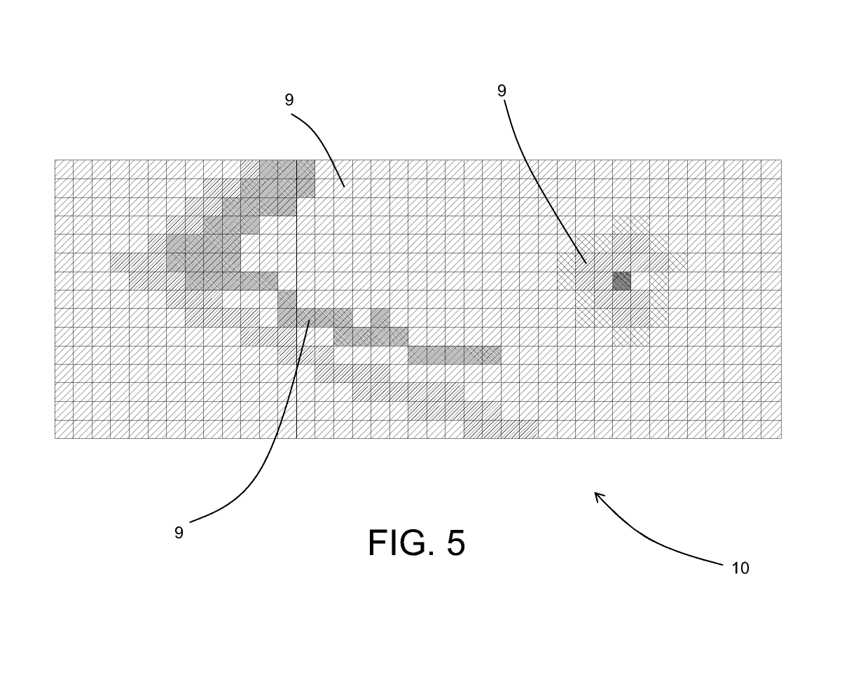

FIG. 5 shows schematically, in front view, a virtual image obtained from the step of FIG. 5.

The method for identifying the cutting pattern for pieces of wood such as logs according to this invention comprises first of all, an operating step from which a virtual three-dimensional model 1 of the density of the piece of wood is obtained. This operating step can be carried out simply by taking a three-dimensional model 1 previously elaborated, and also by elaborating it when the cutting pattern is selected.

Advantageously, the three-dimensional model 1 consists of a plurality of basic volumes 2, each with its own constant density. Note that, for the purposes of this invention, the term basic volumes 2 refers to volumes of material whose size is substantially defined by the resolution with which the three-dimensional model 1 is elaborated (see below for further details).

FIG. 1 shows the illustrative, schematic case of the three-dimensional model 1 of a log (schematically illustrated as a cylinder with elliptical section), showing a plurality of basic volumes 2 that constitute it. Note that in the example shown, the size of basic volumes 2 is represented excessively big, solely to explain the concept in qualitative terms. In reality, the size of each basic volume 2 is as small as possible.

In particular, in the preferred embodiment of this invention, the three-dimensional model 1 of the density of the piece of wood is obtained by taking a tomographic scan of the piece of wood. In this case, the size of each basic volume 2 is therefore given by the resolution of the tomograph in the three spatial dimensions.

The initial step of the method according to this innovation, is therefore to prepare a virtual model 1 of the piece of wood to cut, which model 1 is constituted, as shown in FIG. 1, by the plurality of small cells joined to each other (basic volumes 2), each of which has its own density value, which is assumed to be constant.

For practical purposes, the virtual three-dimensional model 1 of the piece of wood can be managed with the computer, using specific software.

The next step of the method according to this invention is to virtually cut the piece of wood, always by using IT/electronic instruments, by acting on its three-dimensional model 1, thus obtaining virtual semi-finished products 3 (planks, plywood, etc), and to evaluate the quality of these virtual semi-finished products 3 based on the information on density obtained from three-dimensional model 1. Note that in this context, the term “virtual” is always used to indicate that these are not actual operations (such as the cuts) carried out on the actual piece of wood or actual elements, but operations that are carried out on the virtual three-dimensional model 1 of the same piece of wood and elements, obtained with these virtual operations.

The method comprises a selection step of a potential first virtual cutting pattern 4 to apply to the piece of wood.

Indeed, the virtual cutting pattern 4 is in general constituted by one or more virtual cutting surfaces, properly arranged in relation to each other, and once they are applied to three-dimensional model 1 of the piece of wood, with a certain position/orientation in relation to it, allow one or more virtual semi-finished products 3 to be obtained from the piece of wood (in addition to waste material). Note that advantageously, these cutting surfaces can also have a certain thickness, in order to fully or partially reflect an actual cut made on the actual piece of wood (where the material nearby the line of the cutting blade becomes shavings).

FIGS. 2 and 3 show the projection, on the front side of three-dimensional model 1 of FIG. 1, of two different cutting patterns 4 (that can be extended or not, as an advantage, for the entire length of the piece of wood, equally).

In particular, FIG. 2 shows a first cutting pattern 4 constituted by a plurality of first virtual, flat cutting surfaces 5 extending parallel to the main direction of extension of the piece of wood to cut.

Similarly, FIG. 3 shows a first cutting pattern 4 which is also constituted by a plurality of first virtual, flat cutting surfaces 6 extending parallel to the main direction of development of the piece of wood to cut.

Note that the patterns shown in FIGS. 2 and 3 are virtual cutting patterns 4 intended to obtain planks, but there may be different cutting patterns in other embodiments, to obtain particular semi-finished products (such as cylinders or other items).

Once the first virtual cutting pattern 4 has been selected, the method comprises applying it to three-dimensional model 1 of the piece of wood, to obtain one or more virtual semi-finished products 3.

These virtual semi-finished products 3 are nothing but virtual three-dimensional models of pieces of wood which are smaller than the initial piece (the sum of their volumes is equal to the volume of the initial piece of wood, minus the waste volume). Each virtual semi-finished product therefore has its own exterior surface defined by the intersection between one or more virtual cutting surfaces and a series of contiguous basic volumes 2, among those defining three-dimensional model 1. The three-dimensional model of a single plank, showing the basic volumes 2, is shown at the centre of FIG. 4.

After this, the method according to this invention comprises the operating step of virtually associating with the basic volumes 2 defining each virtual semi-finished product 2, the corresponding density established based on three-dimensional model 1.

Once the density association step is concluded, the method according to this invention may comprise the recording of the results obtained for further elaboration (according to the methods indicated below), or their immediate elaboration to obtain additional information that in turn, can be recorded for later use.

Indeed, for each cutting pattern 4, this invention comprises an additional elaboration step, for each virtual semi-finished product, in which its mechanical properties are estimated. This elaboration is performed based on the density of the virtual semi-finished product 3. After associating the density to basic volumes 2, indeed, a three-dimensional map of the density is available for each virtual semi-finished product 3, from which it is possible to obtain the same information that is currently obtained only on actual semi-finished products. As a consequence, this information can be used in a similar way in which the actual information obtained from examining actual semi-finished products is used, thus allowing an estimate of the mechanical properties of the virtual semi-finished products 3, as it is done today, using actual semi-finished products.

For example, three possible methods for estimating the mechanical properties in relation to this invention will be described now, granted that other methods can anyhow be applied.

According to the first method, the step of elaborating an estimate of the mechanical properties of each virtual semi-finished product 3, comprises first of all the operating step of carrying out a virtual plane is projection of the interior density of each virtual semi-finished product 3, according to one or more established directions 7.

This step is schematically shown in FIG. 4, where it is possible to see the three-dimensional model of a virtual semi-finished product 3, subdivided in its basic volumes 2, two arrows 7 indicating the projection senses, and two projection planes 8 which are perpendicular to the directions of the arrows 7.

Advantageously, the established projection senses can be chosen to be perpendicular to one or more exterior faces of each virtual semi-finished product, and/or perpendicular to the main direction of development of the virtual semi-finished product 3 (direction that corresponds in general to the main direction of development of the piece of wood to cut).

Another advantage consists in the fact that the established projection senses can be chosen to be parallel to the direction of the three-dimensional wireframe that defines the basic volumes 2 (as in FIG. 4).

Preferably, the density is projected on the plane with a resolution practically equal to that of three-dimensional model 1.

If the projection takes place with these last two methods, each projected area 9 (FIG. 5) corresponds to the projection of a row of basic volumes 2 aligned exclusively along the projection sense.

According to the needs, the density projection can be quantified point by point, in different ways. Advantageously, this corresponds to the average volume of the densities of the single basic volumes 2 projected in each point (therefore to the average density of all basic volumes 2 projected in that area 9, with the average transversal density of the virtual semi-finished product 3 along that projection line). In other words, this is the virtual simulation of what it could be the radiographic image of the virtual semi-finished product 3, according to projection sense 7.

FIG. 5 represents schematically the image of the possible projection on the lower plane of FIG. 4 of the density of the virtual semi-finished product 3 shown by it, where the darker areas correspond to areas of greater average density (like those where the piece of wood is affected by knots) and the lighter ones correspond to the areas with lower average density (for example those corresponding to pieces of wood free of knots and other internal defects or, on the contrary, those corresponding to areas where interior cavities are present).

Once the projection has been performed, it is possible to examine the results obtained (like those shown in FIG. 5) in order to elaborate a estimate of the mechanical properties of the different virtual semi-finished products 3, using the same methods of analysis currently used to exam the “projections” of actual elements (such as radiographies of actual semi-finished products). In any case, these methods will not be described in details herein, because they are known.

The second example of elaboration of the estimate of the mechanical properties of virtual semi-finished products 3 comprises the operating step of determining the virtual average density of each virtual semi-finished product 3 and estimating the modulus of elasticity of this virtual semi-finished product 3, based on the determined virtual average density, and based on the average density of the piece of wood to cut and modulus of elasticity and/or resonance frequency of this piece of wood to cut (values previously determined with a known method).

The tests carried out by the applicant indeed, allow verification that it is possible to consider in general, that a virtual semi-finished product 3 has the same resonance frequency of the entire piece of wood from which it may be obtained, and therefore, this is probably because the resonance frequency is a property mainly linked to the nature of the fibre that constitutes the wood and as such, is fairly constant inside a single piece of wood.

As a consequence, if the resonance frequency is deemed to be constant, if the virtual average density of each virtual semi-finished product 3 is known, it is possible to estimate with a good level of reliability, the virtual modulus of elasticity of each virtual semi-finished product 3, by applying the formula:

E=δ(2Lf)²

where E is the modulus of elasticity, δ is the average density of the virtual semi-finished product 3, L is the length of the virtual semi-finished product (measured along the direction of interest, to determine the modulus of elasticity) and f is the resonance frequency of the piece of wood in its whole.

The third example of elaboration of the estimate of the mechanical properties of virtual semi-finished products 3, instead comprises the operating step consisting in identifying the knottiness of the virtual semi-finished product 3. Knottiness means the average incidence of the wood with knots in the virtual semi-finished product 3. For example, this incidence can be determined for the overall wood and also for the wood without defects. In addition, this can be determined for the transversal section of the virtual semi-finished product 3, in particular for the transversal section where this incidence is greater. Indeed, since the wood with knots is equal to wood with holes, for purposes of mechanical resistance, the resistance of the entire virtual semi-finished product 3 depends on the resistance of its section mostly affected by knots.

The method according to this invention also comprises, in general, the repetition of the selection steps of cutting pattern 4, the application of the cutting pattern 4 to the three-dimensional model 1 of the piece of wood, the association of the density with virtual semi-finished products 3, and the elaboration of an estimate of the mechanical properties, for a plurality of potential different cutting patterns 4, each of which corresponds to one or more different virtual semi-finished products 3.

In other words, the method comprises the simulation of the cut of the piece of wood in many different ways, so as to compare the results obtained (according to the methods explained below).

In any case, it must be noticed that not necessarily all four of these steps (selection, application, association, and elaboration) must be followed in sequence for a cutting pattern 4 prior to go to the next. Since this is exclusively a virtual elaboration, the sequence of the various steps for the different cutting patterns 4 can be managed in any way deemed useful in view of the final result.

As it is easy to infer, since it is not possible to apply countless cutting patterns 4 to each piece of wood, it is always necessary to previously choose the cutting patterns 4 based on production needs, type of wood, and all the other information provided by the preliminary tests already performed on the piece of wood. In other words, the preferred cutting patterns 4 can be those that are potentially valid from time to time and those selected by the sawmills that decide nowadays, in an arbitrary way.

In general anyhow, the different virtual cutting patterns 4 that are adopted, may differ from each other totally or partially.

The patterns differ totally when the reciprocal layout of the virtual cutting surfaces 5, 6 changes between the cutting patterns 4. This situation is shown for example in FIGS. 2 and 3, where the cutting patterns 4 are completely different from each other.

Instead, they differ partially when the reciprocal layout of the virtual cutting surfaces 5, 6 is the same, but their layout changes compared to the piece of wood.

In other words, the different cutting patterns 4 may have cutting surfaces 5, 6 with different reciprocal orientation/position, and virtual cutting surfaces 5, 6 with the same reciprocal direction but different orientation/position compared to the piece of wood.

According to this invention, the method for choosing the actual cutting pattern with which to cut the piece of wood, comprises a comparison of the estimates of the mechanical properties of the virtual semi-finished products obtained with the different virtual cutting patterns 4 and, based on this comparison, selection from the virtual cutting patterns 4 of the actual cutting pattern based on which the cut will be made on the piece of wood.

The comparison step may have as object, any mechanical property (or more than one) of the virtual semi-finished products 3, determined based on the density previously associated with them.

In any case, the aim of the comparison step is to find among the cutting patterns 4, the one that is able to maximize the overall economic value of semi-finished products 3 obtained from the piece of wood. As a consequence, although this aim can be achieved by comparing directly the mechanical properties of the virtual semi-finished products 3, with regards to the preferred execution method, the method according to this invention comprises, before the comparison step, an additional evaluation step of the economic value of the semi-finished products 3, carried out according to the mechanical properties estimated, and also the comparison step takes place by simply comparing the sums of the economic values of the semi-finished products 3 obtained with each cutting pattern 4.

Therefore, the virtual cutting pattern 4 chosen to become the actual cutting pattern will be the one that allows the maximum overall economic value for semi-finished products 3 to be obtained. Advantageously, therefore, once the density is associated with the semi-finished products 3, it is possible to elaborate an estimate of the mechanical properties and possibly determine the consequent economic value and record, for each cutting pattern 4, either the mechanical properties estimated (such as the modulus of elasticity) or the overall economic value of all semi-finished products 3 obtained with said cutting pattern 4, or both.

As mentioned, therefore, the criteria based on which the comparison will be made, as well as those to assess the economic value, can be multiple, each based on the estimate of different mechanical properties of the semi-finished products 3, which can be elaborated based on their density.

Summarizing what was explained until now, according to this innovation, given a virtual three-dimensional model 1 of the piece of wood to cut, more cutting patterns 4 will be selected, then they will be virtually applied to three-dimensional model 1 to obtain the virtual semi-finished products, and the density obtained from the three-dimensional model will be applied.

At this point, for each density, an estimate is elaborated for one or more mechanical properties of the semi-finished products 3 (such as the modulus of elasticity).

Also in this case, the properties thus determined will be directly compared, or the economic value of the virtual semi-finished products 3 will be assessed, based on these properties. At this point, the comparison will be directly between the overall economic values.

In general, during the comparison step (regardless how it is performed), the final selection step of the virtual cutting pattern 4 will take place, which will become the actual cutting pattern. Advantageously, this pattern corresponds to that with the best properties of the semi-finished products or their maximum economic value.

This invention has important advantages.

First of all, the method for identifying the cutting pattern for pieces of wood such as logs according to this invention allows the cutting pattern to be optimized compared to prior art methods, in the sense that it allows one to estimate, in a reliable manner, the mechanical properties of the semi-finished products obtained with the cut.

Secondly, this method allows the economic value of the semi-finished products obtained from each piece of wood to be maximized.

It must be also pointed out that this invention is fairly easy to produce and the cost for implementing the invention is not very high.

The invention described above may be modified and adapted in several ways without thereby departing from the scope of the inventive concept. All the details can be substituted by other elements which are technically equivalent, according to requirements.

1. A method for identifying the cutting pattern for pieces of wood such as logs, characterised in that it comprises the operating steps of:
obtaining a virtual three-dimensional model (1) of the density of a piece of wood, said three-dimensional model (1) consisting of a plurality of basic volumes (2) each having its own constant density;
selecting a possible first virtual cutting pattern (4) for the piece of wood which may allow one or more semi-finished products (3) to be obtained from the piece of wood, said cutting pattern (4) consisting of one or more virtual cutting surfaces (5), (6);
virtually applying the first virtual cutting pattern (4) to the three-dimensional model (1) of the piece of wood to obtain one or more virtual semi-finished products (3), each formed by a plurality of basic volumes (2);
is virtually associating with the basic volumes (2) forming each virtual semi-finished products (3), the corresponding density identified on the basis of the three-dimensional model (1);
processing, for each virtual semi-finished product (3), an estimate of its mechanical properties based on its density;
repeating the selection, application, association and processing steps for a plurality of different possible cutting patterns (4), each corresponding to one or more different virtual semi-finished products (3);
comparing the estimates of the mechanical properties of the virtual semi-finished products (3) which can be obtained using the different cutting patterns (4); and
on the basis of that comparison, selecting from the virtual cutting patterns (4) one cutting pattern (4) which can be used for proceeding with actual cutting of the piece of wood.

2. The method according to claim 1, characterised in that it also comprises, for each virtual cutting pattern (4), the operating step of identifying the economic value of the virtual semi-finished products (3) which can be obtained with the cutting pattern (4) based on the estimate of their mechanical properties, and also being characterised in that the actual cutting pattern is selected on the basis of a comparison between the overall economic values of the semi-finished products (3) which can be obtained with each cutting pattern (4).

3. The method according to claim 2, characterised in that the actual cutting pattern is selected as the virtual cutting pattern (4), amongst those examined, which guarantees the maximum overall economic value of the semi-finished products (3) which can be obtained with it.

4. The method according to claim 3, characterised in that the step of processing an estimate of the mechanical properties of each virtual semi-finished product (3) involves the operating step of performing a virtual plane projection of the inner density of each virtual semi-finished products in one or more predetermined directions (7).

5. The method according to claim 1, characterised in that the step of processing an estimate of the mechanical properties of each virtual semi-finished product (3) involves the operating step of performing a virtual plane projection of the inner density of each virtual semi-finished products in one or more predetermined directions (7).

6. The method according to claim 5, characterised in that the one or more predetermined directions (7) are selected so that they are perpendicular respectively to one or more outer faces of each virtual semi-finished product.

7. The method according to claim 3, characterised in that the step of processing an estimate of the mechanical properties also comprises the operating step of evaluating, for each virtual semi-finished product (3), the average transversal density point by point in one or more predetermined directions.

8. The method according to claim 1, characterised in that the step of processing an estimate of the mechanical properties also comprises the operating step of evaluating, for each virtual semi-finished product (3), the average transversal density point by point in one or more predetermined directions.

9. The method according to claim 8, characterised in that the one or more predetermined directions (7) are selected so that they are perpendicular respectively to one or more outer faces of each virtual semi-finished product.

10. The method according to claim 9, characterised in that the step of evaluating the average transversal density point by point coincides with the step performing a virtual plane projection of the density.

11. The method according to claim 8, characterised in that the one or more predetermined directions (7) are selected so that they are parallel with a direction of extension of a virtual wireframe defining the basic volumes (2) of the three-dimensional model (1).

12. The method according to claim 11, characterised in that the step of evaluating the average transversal density point by point coincides with the step performing a virtual plane projection of the density.

13. The method according to claim 1, characterised in that the step of processing an estimate of the mechanical properties of each virtual semi-finished product (3) based on its density involves the operating step of identifying the virtual average density of each virtual semi-finished product (3) and estimating the modulus of elasticity of that virtual semi-finished product (3) according to the virtual average density identified in that way, and based on the resonance frequency of the piece of wood to be cut.

14. The method according to claim 13, characterised in that the step of estimating the modulus of elasticity is carried out considering that each virtual semi-finished product (3) has the same resonance frequency as the whole piece of wood from which it may be obtained.

15. The method according to claim 3, characterised in that the step of processing an estimate of the mechanical properties of each virtual semi-finished product (3) based on its density involves the operating step of identifying the virtual average density of each virtual semi-finished product (3) and estimating the modulus of elasticity of that virtual semi-finished product (3) according to the virtual average density identified in that way, and based on the resonance frequency of the piece of wood to be cut.

16. The method according to claim 1, characterised in that the step of processing an estimate of the mechanical properties of each virtual semi-finished product (3) based on its density involves the operating step of identifying the knottiness of the virtual semi-finished product (3), the knottiness being the incidence of wood affected by knots compared with the overall wood or with the wood which is free of defects.

17. The method according to claim 1, characterised in that the virtual cutting patterns (4) each comprise a plurality of flat virtual cutting surfaces (5, 6) extending parallel with a main direction of extension of the piece of wood to be cut.

18. The method according to claim 1, characterised in that two or more virtual cutting patterns (4) have virtual cutting surfaces (5, (6) with the same reciprocal orientation but with different orientation/positioning relative to the piece of wood.

19. The method according to claim 1, characterised in that the step of obtaining a virtual three-dimensional model (1) of the density of the piece of wood is carried out by performing a tomographic scan of the piece of wood.
